(19) United States
(12) Patent Application Publication
(10) Pub. No.: US 2013/0313307 A1
(43) Pub. Date: Nov. 28, 2013

(54) METHOD FOR MANUFACTURING A HOT GAS PATH COMPONENT

(71) Applicants: Benjamin Paul Lacy, Greer, SC (US); Srikanth Chandrudu Kottilingam, Simpsonville, SC (US); Brian Lee Tollison, Honea Path, SC (US)

(72) Inventors: Benjamin Paul Lacy, Greer, SC (US); Srikanth Chandrudu Kottilingam, Simpsonville, SC (US); Brian Lee Tollison, Honea Path, SC (US)

(73) Assignee: General Electric Company

(21) Appl. No.: 13/479,710

(22) Filed: May 24, 2012

(51) Int. Cl. B23K 31/02

(52) U.S. Cl. 228/165

(57) ABSTRACT

A method for manufacturing a cooling passage in a component of a machine is described. The method may include: forming a channel in a surface of the component, the channel having a predetermined configuration; forming a cover wire, the cover wire having a predetermined configuration based on the predetermined configuration of the channel; nesting the cover wire in the channel; and welding the nested cover wire to the component such that the channel is enclosed.

### BACKGROUND OF THE INVENTION

This application is related to [GE Docket 252388] and [GE Docket 252769] filed concurrently herewith, which are fully incorporated by reference herein and made a part hereof.

The subject matter disclosed herein relates to industrial machinery, such as turbomachinery, subject to high operating temperatures. More particularly, but not by way of limitation, the subject matter relates to cooling passages and the formation of cooling passages in hot gas path components of turbines.

In a turbine, for example, a combustor converts the chemical energy of a fuel or an air-fuel mixture into thermal energy. The thermal energy is conveyed by a fluid, often compressed air from a compressor, to a turbine where the thermal energy is converted to mechanical energy. As part of the conversion process, hot gas is flowed over and through portions of the turbine. High temperatures along the hot gas path can heat turbine components, causing degradation of components. Forming cooling channels in the components by casting limits the proximity of the channels to the surface of the component to be cooled. Accordingly, the effectiveness of cooling channels is limited, thereby increasing thermal stress experienced by turbine components along the hot gas path.

One known manner for dealing with this issue is to enclose open channels formed on the surface of the component. One known method for doing this is to enclose the channels with a coating. In this case, the formed channel is filled with filler. Then, a surface coating is applied to the surface of the component, covering the outer surface of the filler. Once the coating hardens, the filler is leached from the channel such that a hollow, enclosed cooling channel is created that is positioned very close to the surface of the component. However, while this method has been used with a certain amount of success, the filler/leaching process is time-consuming and expensive, and, because the channel is enclosed by only a layer of coating, issues regarding the durability of the channel may arise. In a similar known method, the open channel is formed with a narrow neck near the surface level of the component that supports the coating without the addition of filler. It will be appreciated, though, that this type of channel geometry greatly complicates the machining process, limits channel size and inlet or feed-hole diameter, limits the type and viscosity of coatings that may be used, and still introduces durability questions. To address durability questions, another known method covers the surface of the component with a plate or foil that is brazed on the surface such that all the channels formed on the surface are covered. However, this process is typically limited to flat areas of the component and adds significant machining time to the overall process.

As such, there is a need for improved and robust cooling passages positioned formed close to the surface of components subject to extreme temperatures. Additionally, there is a need for improved methods by which these surface cooling passages may be constructed in an efficient and cost-effective manner.

### BRIEF DESCRIPTION OF THE INVENTION

According to one aspect of the invention, a method for manufacturing a cooling passage in a component of a machine, the method comprising the steps of: forming a channel in a surface of the component, the channel having a predetermined configuration; forming a cover wire, the cover wire having a predetermined configuration based on the predetermined configuration of the channel; nesting the cover wire in the channel; and welding the nested cover wire to the component such that the channel is enclosed.

These and other features of the present application will become apparent upon review of the following detailed description of the preferred embodiments when taken in conjunction with the drawings and the appended claims.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a turbomachine system;

FIG. 2 is a perspective view of an exemplary hot gas path component, a turbine rotor blade;

FIG. 3 is a perspective view of an exemplary surface on a hot gas path component in which channels have been formed according to one aspect of the present invention;

FIG. 4 is a perspective view of an exemplary shape of the channel of FIG. 3 according to one aspect of the present invention;

FIG. 5 is a side view of an alternative shape of the channel of FIG. 3 according to one aspect of the present invention;

FIG. 6 is a side view of an alternative shape of the channel of FIG. 3 according to one aspect of the present invention;

FIG. 7 is a side view of an alternative shape of the channel of FIG. 3 according to one aspect of the present invention;

FIG. 8 is a perspective view of a channel and cover wire according to one aspect of the present invention;

FIG. 9 is a perspective view of a channel and cover wire according to one aspect of the present invention;

FIG. 10 is a perspective view of a channel and cover wire along a surface on a hot gas path component according to one aspect of the present invention;

FIG. 11 is a perspective view of a channel and cover wire after the welding of the cover wire according to one aspect of the present invention;

FIG. 12 is a perspective view of a channel and cover wire after the welding and smoothing of the cover wire according to one aspect of the present invention; and

FIG. 13 is a block diagram illustrating an exemplary method of forming surface cooling passages according to one aspect of the present invention.

The detailed description explains embodiments of the invention, together with advantages and features, by way of example with reference to the drawings.

### DETAILED DESCRIPTION OF THE INVENTION

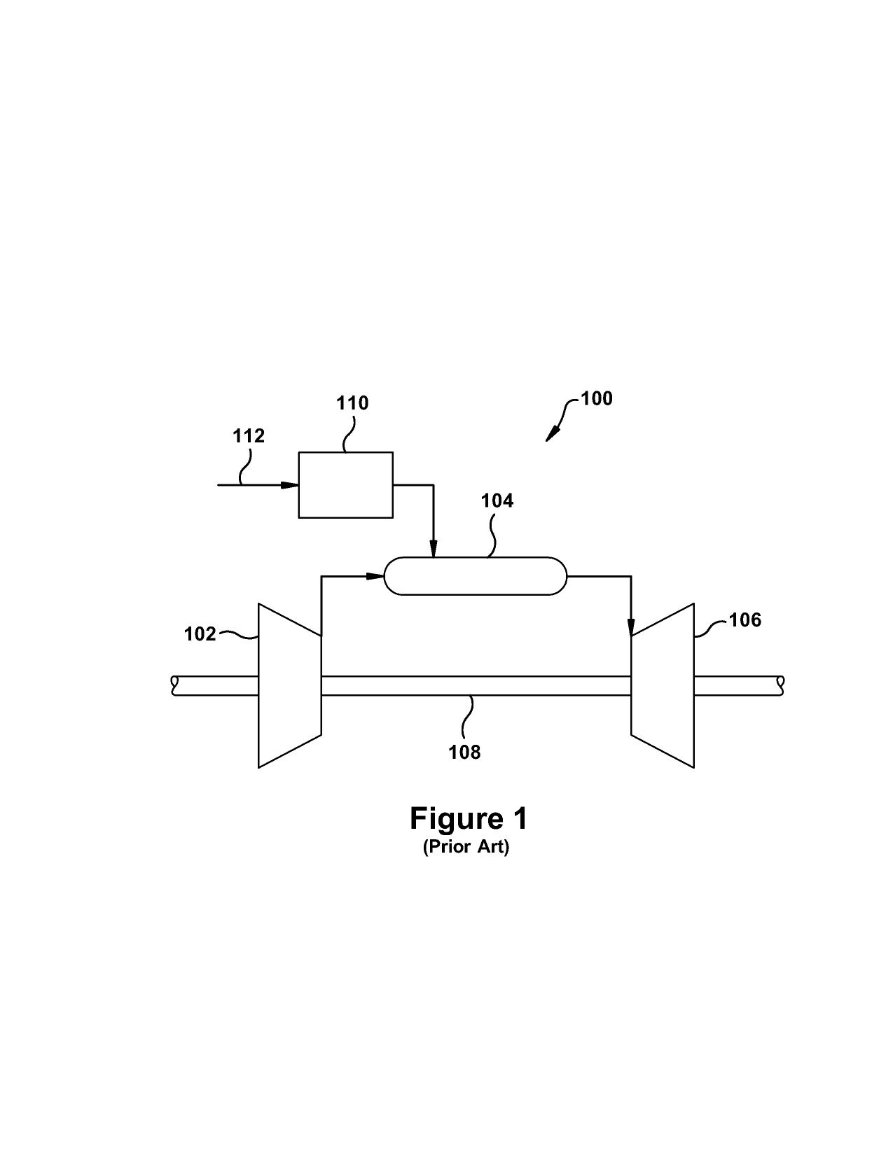

FIG. 1 is a schematic diagram of an embodiment of a turbomachine system, such as a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. The compressor 102 and turbine 106 are coupled by the shaft 108. The shaft 108 may be a single shaft or a plurality of shaft segments coupled together to form shaft 108.

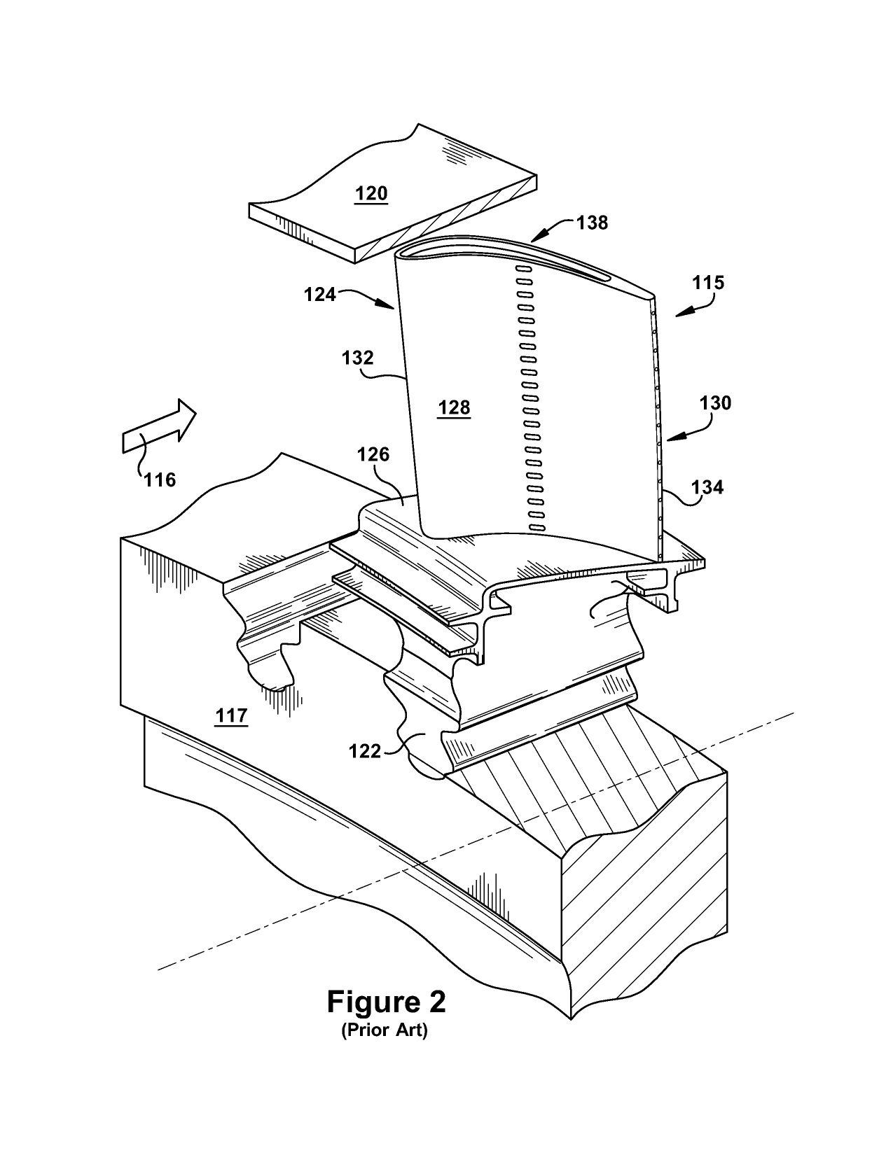

In an aspect, the combustor 104 uses liquid and/or gas fuel, such as natural gas or a hydrogen rich synthetic gas, to run the engine. For example, fuel nozzles 110 are in fluid communication with an air supply and a fuel supply 112. The fuel nozzles 110 create an air-fuel mixture, and discharge the air-fuel mixture into the combustor 104, thereby causing a combustion that creates a hot pressurized exhaust gas. The combustor 100 directs the hot pressurized gas through a transition piece into a turbine nozzle (or “stage one nozzle”), and other stages of buckets and nozzles causing turbine 106 rotation. The rotation of turbine 106 causes the shaft 108 to rotate, thereby compressing the air as it flows into the compressor 102. In an embodiment, hot gas path components, including, but not limited to, shrouds, diaphragms, nozzles, buckets and transition pieces are located in the turbine 106, where hot gas flow across the components causes creep, oxidation, wear and thermal fatigue of turbine parts. Controlling the temperature of the hot gas path components can reduce distress modes in the components. The efficiency of the gas turbine increases with an increase in firing temperature in the turbine system 100. As the firing temperature increases, the hot gas path components need to be properly cooled to meet service life. Components with improved arrangements for cooling of regions proximate to the hot gas path and methods for making such components are discussed in detail below with reference to FIGS. 2 through 12. Although the following discussion primarily focuses on gas turbines, the concepts discussed are not limited to gas turbines.

FIG. 2 is a perspective view of an exemplary hot gas path component, a turbine rotor blade 115 which is positioned in a turbine of a gas turbine or combustion engine. It will be appreciated that the turbine is mounted directly downstream from a combustor for receiving hot combustion gases 116 therefrom. The turbine, which is axisymmetrical about an axial centerline axis, includes a rotor disk 117 and a plurality of circumferentially spaced apart turbine rotor blades (only one of which is shown) extending radially outwardly from the rotor disk 117 along a radial axis. An annular turbine shroud 120 is suitably joined to a stationary stator casing (not shown) and surrounds the rotor blades 115 such that a relatively small clearance or gap remains therebetween that limits leakage of combustion gases during operation.

Each rotor blade 115 generally includes a root or dovetail 122 which may have any conventional form, such as an axial dovetail configured for being mounted in a corresponding dovetail slot in the perimeter of the rotor disk 117. A hollow airfoil 124 is integrally joined to dovetail 122 and extends radially or longitudinally outwardly therefrom. The rotor blade 115 also includes an integral platform 126 disposed at the junction of the airfoil 124 and the dovetail 122 for defining a portion of the radially inner flow path for combustion gases 116. It will be appreciated that the rotor blade 115 may be formed in any conventional manner, and is typically a one-piece casting. It will be seen that the airfoil 124 preferably includes a generally concave pressure sidewall 128 and a circumferentially or laterally opposite, generally convex suction sidewall 130 extending axially between opposite leading and trailing edges 132 and 134, respectively. The sidewalls 128 and 130 also extend in the radial direction from the platform 126 to a radially outer tip or blade tip 137.

Further, the pressure and suction sidewalls 128 and 130 are spaced apart in the circumferential direction over the entire radial span of airfoil 124 to define at least one internal flow chamber or channel for channeling cooling air through the airfoil 124 for the cooling thereof. Cooling air is typically bled from the compressor in any conventional manner. The inside of the airfoil 124 may have any configuration including, for example, serpentine flow channels with various turbulators therein for enhancing cooling air effectiveness, with cooling air being discharged through various holes through airfoil 124 such as conventional film cooling holes and/or trailing edge discharge holes. It will be appreciated that such inner cooling passages may be configured or used in conjunction with the surface cooling channels of the present invention via machining an passage that connects the inner cooling passage to the formed surface channel. This may be done in any conventional manner. In addition, as discussed in more detail below, surface channels according to the present invention may be formed to intersect existing coolant outlets such that, once the surface channel is enclosed, the pressurized coolant forces the flow of coolant through the surface channel. The rotor blade assembly of FIG. 2, as stated, is exemplary, and not intended to foreclose usage of the present invention on other turbine components or components in other industrial machinery. In the case of the rotor blade 115 of FIG. 2, it will be appreciated that the surface cooling channels of the present invention may be employed on any component that contacts the hot gases of the flow path through the turbine, including, for example, the airfoil, stationary airfoils, the platform, the shroud, endwalls, the blade tip, etc.

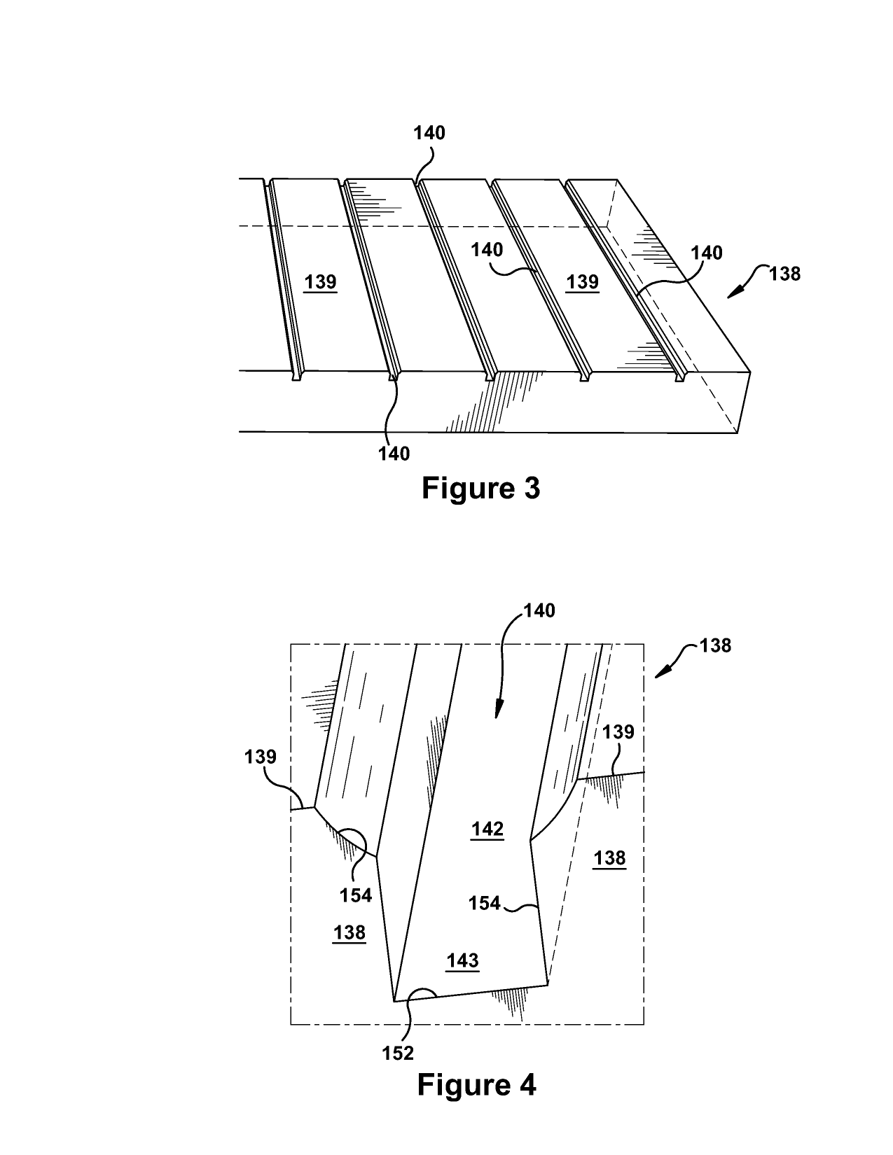

As previously mentioned, positioning interior cooling passages very near the surface of a hot gas path component is a highly effective way to cool a hot gas path component. However, as one of ordinary skill in the art will recognize, these passages, which are sometimes referred to “microchannels” or “surface cooling passages,” are difficult to manufacture because of how close they must be positioned near the surface. As such, fabricating them by traditional means, such as casting, is impossible or highly expensive. As discussed below in relation to FIGS. 3 through 13, the present invention describes an improved microchannel configuration as well as an efficient and cost-effective method by which these surface cooling passages may be fabricated. That is, the present application utilizes a shallow channel or groove formed on surface of the component and encloses the channel using a cover wire that is welded thereto. The cover wire may be sized such that, when welded along its edges, the channel is tightly enclosed while remaining hollow through an inner region where coolant is routed.

FIG. 3 is a perspective view of an exemplary surface 138 on a component 139, which, for example, may be a hot gas component in a turbine engine, in which open channels or channels 140 have been formed according to one aspect of the present invention. As illustrated, the channels 140 may be arranged parallel and in spaced relation across the exemplary surface 138, though other configurations are possible. The channels 140 may be formed via a post-casting machining process. The channels 140 also may be cast into the surface 138 of the component 139.

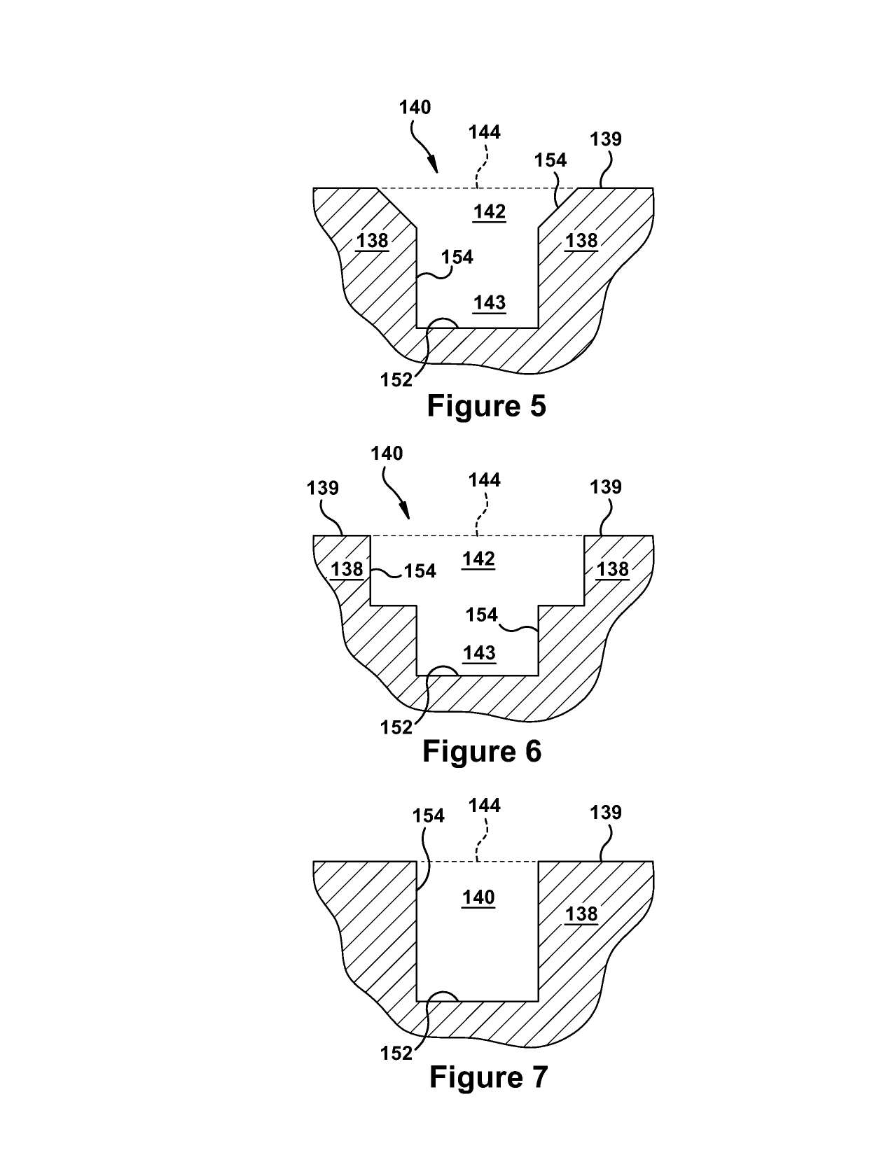

As shown more clearly in FIGS. 4 through 7, the channels 140 may be described as having a mouth or mouth region 142 and an inner region 143. As illustrated, the mouth region 142 and the inner region 143 are differentiated via their respective depths within the channel 140. Specifically, the mouth region 142 resides nearer to a surface level 144 (i.e., the level of the surface 138 of the component 139), and the inner region 143 resides inward of the mouth region 143 (i.e., the deeper portion within the channel 140). The channel 140 may be described as having a floor 152 and sidewalls 154. In preferred embodiments, as illustrated, the channel 140 has a profile wherein the mouth region 142 is wider than the inner region 143. (Note that “profile” as used herein means the shape of the channel 140 as provided from the perspective of FIGS. 5 through 7.)

In preferred embodiments, the portion of the channel 140 nearer the surface 139 of the component (i.e., the mouth region 142) is wider than the interior of the channel 140 (i.e., the inner region 143 nearer the floor 152). This configuration may be achieved via sidewalls 154 that taper within the mouth region 142 of the channel 140. The tapering may have a curved profile as provided in FIG. 4. In this case, the sidewalls 154 may be curved inwardly (i.e., forming a concave surface) and be defined by a radius of curvature. In another embodiment, as illustrated in FIG. 5, the taper within the mouth region 142 may be linear. In a preferred embodiment of this type, the tapering sidewalls 154 of the mouth region 142 may be described as forming an angle with the surface level 144 of between 30 and 60 degrees. In either of these alternatives, the mouth 142 tapers from a maximum channel width near the surface level 144 to a minimum channel width near the inner region 143. The inner region 143 then may maintain a constant width to the floor 152 of the channel 140, though other configurations are also possible. As illustrated in FIG. 6, the mouth region 142 and inner region 143 may form a step configuration. It should be appreciated that, in some embodiments, the channel may have a constant width at all depth levels, as illustrated in FIG. 7, though the tapering mouth or step configuration may be preferable for reasons discussed below.

The channels 140 may be relatively narrow and shallow in depth, and particular dimensions may be varied to suit particular applications. Cross sections may be square, round, or other appropriate shapes. Cross sections can vary in area along the channel length and can have heat transfer enhancement features such as turbulators. Typically, however, given the desired objective of concentrating cooling toward the surface of the hot gas path component, in preferred embodiments, such as those applications involving turbine rotor blades, stator blades, or shrouds, a maximum channel depth may be substantially constant along the length of the channel 140, and be between 0.010 and 0.1 inches. A maximum channel width through the mouth region 142 of the channel 140 may be substantially constant along the length of the channel 140, and be between 0.020 and 0.11 inches. And, a maximum channel width through the inner region 143 of the channel 140 may be substantially constant along the length of the channel 140, and be between 0.01 and 0.1 inches.

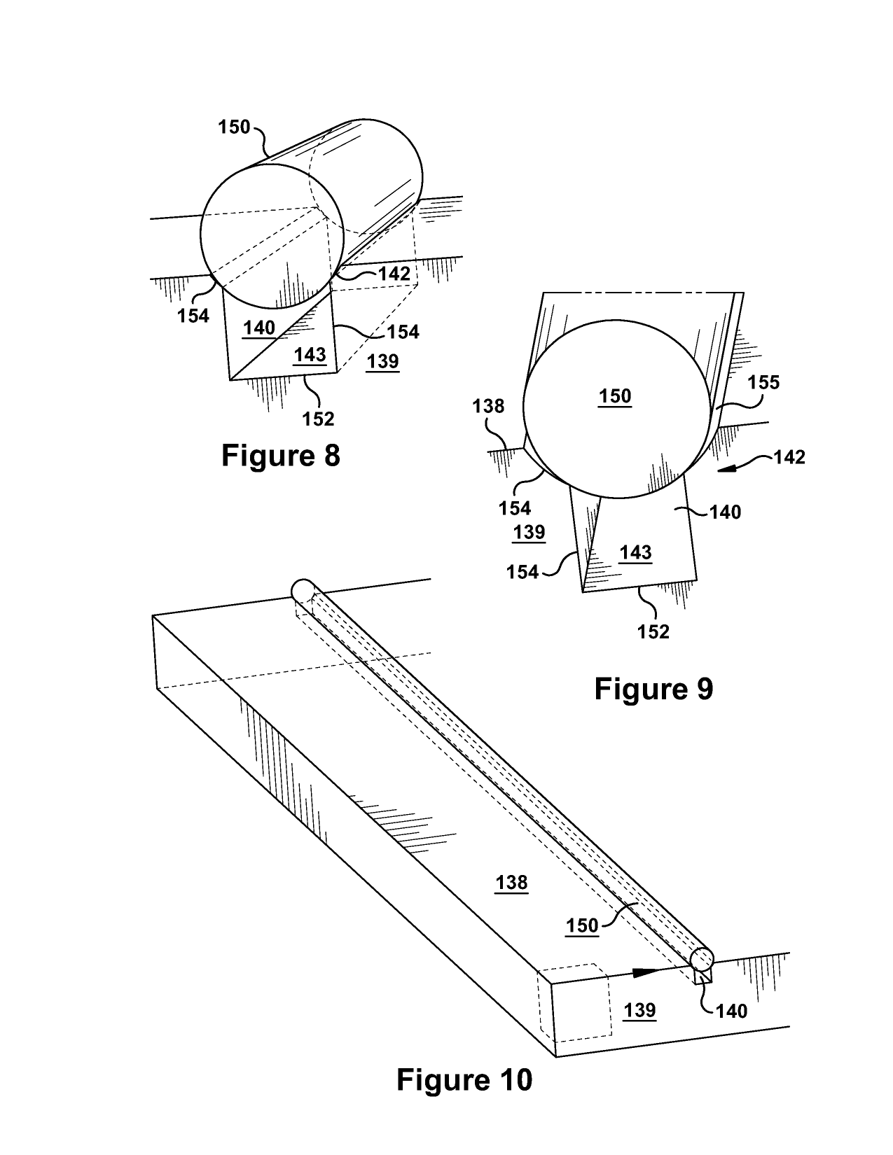

FIGS. 8 through 10 show the cover wire 150 as it may be configured and positioned within the channel 140 during fabrication. The cover wire 150 may be a metallic wire made of solid solution strengthened filler metals such as IN617, IN625, H230, Hastelloy W, Haynes 25, MarM918, and precipitation hardened filler metals such as Haynes 282, Rene 41, Waspalloy, GTD222, Nimonic C263, Rene 80, GTD111, or other suitable materials. In a preferred embodiment, the cover wire 150 may have a circular cross-section, as illustrated, though other cross-sectional shapes are possible. The cover wire 150 may be sized in conjunction with the channel 140 so that the cover wire 150 “nests” within the channel in a desired manner. In a preferred embodiment, the cover wire 150 extends into a portion of the channel 150, but then be stopped via the narrowing of the sidewalls 154 of the channel 140 such that a significant portion of the inner region 143 remains open. Once properly nested, the cover wire 150 may achieve a desired attachment position. In this position, the welding of the cover wire 150 to the surface 138 of the component 139 may proceed efficiently and produce a robust cover that encloses the channel 140. It will be appreciated that the usage of a wire to enclose the channels utilizes a readily available, cost-effective component.

In a preferred embodiment, the sidewalls 154 of the mouth region 142 are curved in a manner that forms a concave surface, as shown in FIG. 4. The curvature may be defined by a radius of curvature. As illustrated in FIGS. 8 through 10, in preferred embodiments, the radius of curvature of the sidewalls 154 of the mouth 142 relates in a desired manner to the radius of curvature of a circular cover wire 150. For example, in FIG. 8, the mouth region 142 is shallow, but has a radius of curvature that is approximately the same as the circular cover wire 150. It will be appreciated that this configuration allows the cover wire 150 to nest within the channel 140 such that the contact area between the cover wire 150 and the component 139 is increased. In this case, the entirety of the sidewalls 154 of the mouth region 142 contacts the cover wire 150 along its length. This increased contact area may make attaching the cover wire 150 to the component 139 easier as well as improving the robustness of the connection and seal that is formed between the cover wire 150 and the sidewalls 154 of the channel 140.

The inner region 143 may be configured with a channel width that is less than the diameter of the circular cover wire 140. Sized in this manner the cover wire 150 is prevented from advancing too far into the channel 140 upon being installed. In preferred embodiments, the width of the inner region 143 and the diameter of the cover wire 150 are jointly configured such that a desired nesting or attachment configuration is achieved, which, for example, may include: a desired clearance between the cover wire 150 and the floor 152 of the channel 140; a desired contact area between the cover wire 150 and the sidewalls 154 of the channel 140; a desired height the cover wire 150 extends above the surface level 144; a desired portion of the cover wire 150 contained within the channel 140; etc.

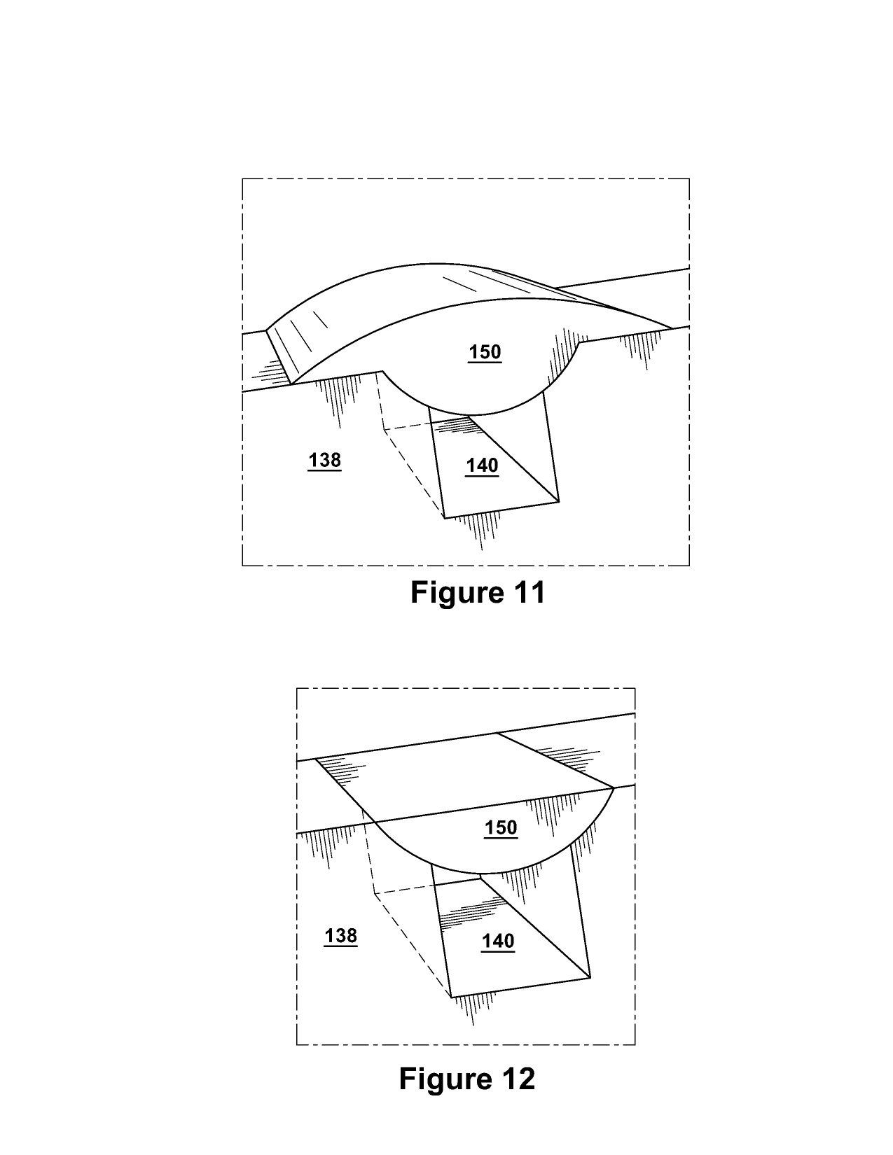

Another example of how the cover wire 150 and channel 140 may be configured is provided in FIG. 9. In this example, the mouth region 142 extends deeper into the surface 138 of the component 139 such that approximately half of the cover wire 150 is contained within the mouth region 142 once it is nested therein. In some preferred embodiments, the radius of the curvature of the mouth region 142 may be similar to that of the cover wire 150. As illustrated in FIG. 9, the radius of the cover wire 150 may be slightly less than the radius of the curvature of the sidewalls 154 of the mouth region 142. In this preferred embodiment, an outward facing gap 155 is created between the cover wire 150 and the sidewalls 154 of the mouth region 142. During the attachment process, the outward facing gap 155 may allow the cover wire 150 to deform outwardly to fill the gap 155 as the cover wire 150 is heated, which is illustrated in FIGS. 11 and 12. It will be appreciated that this configuration may result in a very large contact area being formed between the cover wire 150 and the sidewalls 154 of the mouth region 142.

FIG. 11 is a perspective view of a channel 140 and cover wire 150 after the welding of the cover wire 150 according to one aspect of the present invention. The welding may be done via laser welding or any other conventional welding techniques. The cover wire 150 may be welded so that the edges of the cover wire 150 weld to the side walls 154 of the mouth region 142, while leaving the inner region 143 open. It will be appreciated that the welding may be completed using conventional techniques, such as arc welding (including GTAW, PAW, GMAW-short circuiting), laser welding (continuous or pulsed), or electron beam welding.

FIG. 12 is a perspective view of a channel 140 and cover wire 150 after smoothing of the cover wire 140 is complete. Specifically, the overflow of metal on the surface 138 of the component 139 may be machined away via any conventional machining technique. As shown, once complete, the channel 140 is enclosed by the cover wire 150, which, given the durability of the wire and the welding process, may provide a tightly sealed, robust cover. The channel 140 now provides an enclosed surface cooling passage or microchannel through which coolant may be circulated.

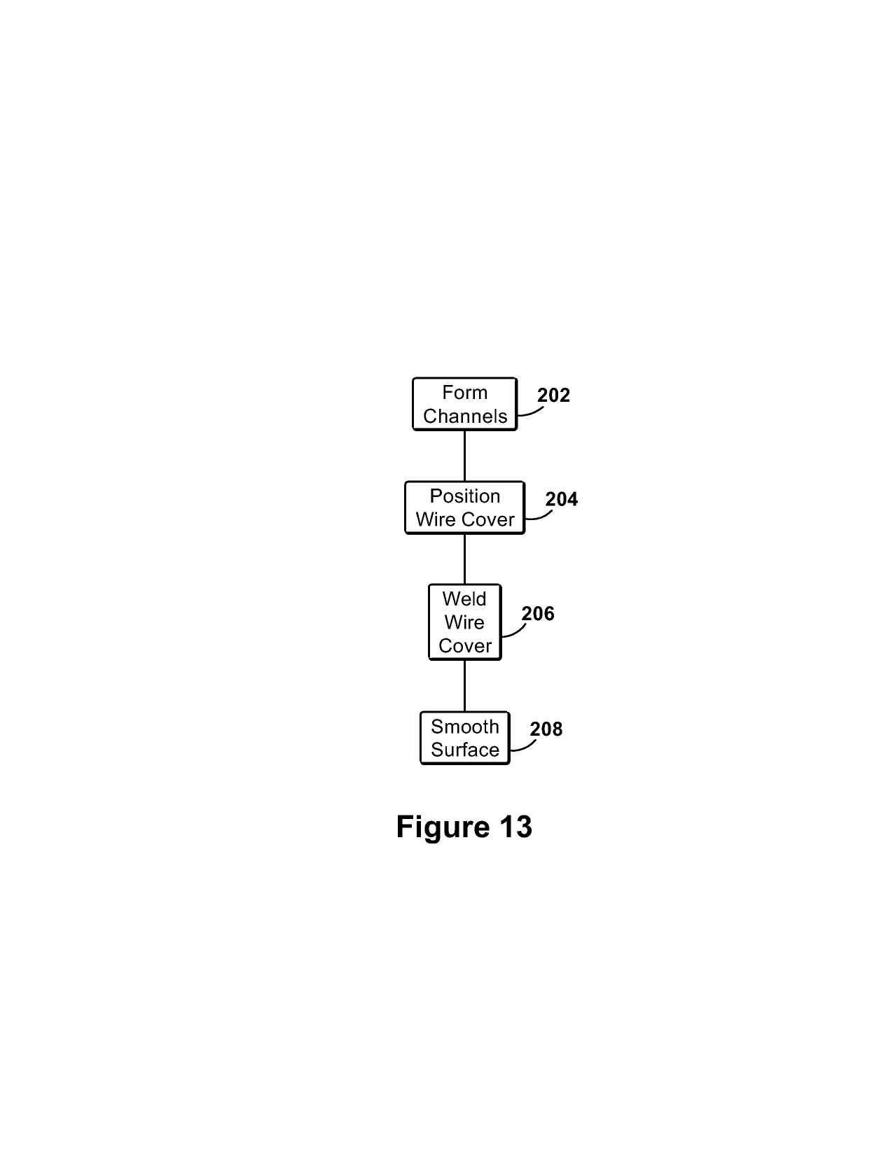

FIG. 13 is a block diagram illustrating an exemplary method of forming surface cooling passages according to one aspect of the present invention. At an initial step, step 202, the channels 140 may be formed on the surface 138 of the hot gas path component 139. The channels 140 may be formed by any conventional machining or casting process. The channels 140 may also be formed to connect to connectors or feeds that connect to a coolant supply that circulates through the hollow airfoil during usage. At a step 204, the cover wire 150 may be placed in position or nested within the channels 140. At a step 206, the cover wire 150 may be welded to the component 139, thereby enclosing the channel 140. Finally, at a step 208, excess material from the cover wire 150 and/or the welding process may be machined away such that a smooth surface remains.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

We claim:

1. A method for manufacturing a cooling passage in a component of a machine, the method comprising:
forming a channel in a surface of the component, the channel having a predetermined configuration;
forming a cover wire, the cover wire having a predetermined configuration based on the predetermined configuration of the channel;
nesting the cover wire in the channel; and
welding the nested cover wire to the component such that the channel is enclosed.

2. The method of claim 1, wherein the predetermined configurations of the cover wire and the channel allow, once the step of the cover wire is nested in the channel, a portion of the cover wire to extend into the channel while maintaining a clearance between the cover wire and a floor of the channel.

3. The method of claim 1, wherein the component comprises a hot gas component in a combustion turbine engine.

4. The method of claim 3, wherein the component comprises one of a rotor blade or a shroud in a turbine of the combustion turbine engine.

5. The method of claim 1, wherein the channel comprises a narrow, shallow groove;
wherein the step of:
forming the channel in the surface of the component includes forming a plurality of the channels spaced over the surface of the component;
forming the cover wire includes forming a plurality of the cover wires;
nesting the cover wire in the channel includes nesting one of the cover wires in each of the plurality of channels; and
welding the nested cover wire to the component such that the channel is enclosed includes welding each of the nested cover wires to the component such that each of the plurality of channels is enclosed.

6. The method of claim 1, wherein the channel is configured to comprise opposing sidewalls that define sides of the channel and a floor that defines a deepest extent of the channel; and
wherein a channel width comprises a distance between the opposing sidewalls;
wherein a channel depth comprises a distance between a surface level of the component to the floor of the channel.

7. The method of claim 6, wherein the channel is configured to comprise two regions differentiated by relative depth within the channel:
a mouth region that resides nearer to the surface level; and
an inner region that resides between the mouth region and the floor; and
wherein the channel width of the mouth region is greater than the channel width of the inner region.

8. The method of claim 7, wherein the sidewalls of the mouth region and the inner region comprise a step configuration.

9. The method of claim 7, wherein the sidewalls within the mouth region taper from a maximum channel width near the surface level to a minimum channel width near the inner region of the channel.

10. The method of claim 9, wherein the tapering sidewalls of the mouth comprise a linear profile.

11. The method of claim 10, wherein the tapering sidewalls of the mouth comprise an angle of between 30 and 60 degrees with the surface level of the component.

12. The method of claim 9, wherein the inner region is configured to comprise an approximate rectangular configuration, wherein the sidewalls are approximately perpendicular to the surface level and the floor that is approximately parallel to the surface level.

13. The method of claim 9, wherein the tapering sidewalls of the mouth comprise a concave surface having a curved profile.

14. The method of claim 13, wherein the curved profile of the mouth is defined by a radius of curvature; and
wherein the cover wire is configured to have a circular cross-section, the circular cross-section of the cover wire defined by a radius of curvature.

15. The method of claim 14, wherein the cover wire and the channel are configured such that, once the cover wire is nested within the channel, a portion of the cover wire extends into the channel, but the narrowing of the sidewalls prevents the cover wire from extending further into the channel such that a desired clearance is maintained between the nested cover wire and the floor; and
wherein the desired clearance corresponds to a desired unobstructed cross-sectional flow area through the channel.

16. The method of claim 15, wherein the radius of curvature of the sidewalls of the mouth and the radius of curvature of the cover wire are configured to produce desired contact area between the channel and the cover wire once the cover wire is nested therein.

17. The method of claim 16, wherein the radius of the curvature of the mouth is approximately the same as the radius of the cover wire.

18. The method of claim 16, wherein the radius of the cover wire is slightly less than the radius of the curvature of the sidewalls of the mouth such that an outward facing gap is created between the cover wire and the sidewalls of the mouth.

19. The method of claim 1, wherein the channel and the cover wire are configured such that, once the cover wire is nested within the channel, the cover wire comprises a desired attachment position.

20. The method of claim 19, wherein the desired attachment position comprises one that:
allows the cover wire to extend into the channel a desired distance;
maintains a desired clearance between the cover wire and a floor of the channel;
produces desired contact area between the cover wire and the sidewalls of the channel; and
results in the cover wire extending a desired distance above the surface level of the component.

21. The method of claim 20, wherein the desired attachment position comprises one that results in between 20% and 100% of the cover wire resting below the surface level of the component.

22. The method of claim 1, wherein step of welding the cover wire to the component comprises welding the cover wire so that the edges of the cover wire weld to the surface of the mouth; and
wherein the welding results in the channel being substantially enclosed by the cover wire.

23. The method of claim 1, further comprising the step of machining an overflow of cover wire present on the surface of the component after the welding step such that the surface of the component is smooth.

24. The method of claim 9, wherein a maximum channel depth is substantially constant along the length of the channel, wherein the maximum channel depth is between 0.01 and 0.1 inches;
wherein a maximum channel width through the mouth region of the channel is substantially constant along the length of the channel, wherein the maximum channel width of the mouth region of the channel is between 0.02 and 0.11_inches;
wherein a maximum channel width through the inner region of the channel is substantially constant along the length of the channel, wherein the maximum channel width of the inner region of the channel is between 0.01 and 0.1 inches.
